(19) United States
(12) Patent Application Publication
(10) Pub. No.: US 2012/0168401 A1
(43) Pub. Date: Jul. 5, 2012

(54) CONTAINER OF A THERMOPLASTIC MATERIAL

(75) Inventors: Bastian Tissmer, Regensburg (DE); Jörg Wortmann, Rimbach (DE)

(73) Assignee: KRONES AG, Neutraubling (DE)

(21) Appl. No.: 13/334,244

(22) Filed: Dec. 22, 2011

(30) Foreign Application Priority Data
Dec. 23, 2010 (DE) 102010064125.1

(51) Int. Cl. B65D 1/02; B29C 49/00; G06F 17/50; B65D 23/00

(52) U.S. Cl. 215/372; 425/522; 703/1

(57) ABSTRACT

A container of a thermoplastic material, in particular a plastic bottle, comprising a bottom comprising a first and a second surface area, where the first and the second surface area, at a constant radius with respect to the longitudinal axis of the container, each have a constant distance to a plane surface arranged to be perpendicular to the longitudinal axis, where the first surface area is offset with respect to the second surface area towards the interior of the container, where the first and the second surface area are connected by a third surface area which is embodied in the form of a coherent loop band and comprises at least three loops, and where the transition between the first surface area and the third surface area, and/or the transition between the second surface area and the third surface area are continuously differentiable at least once, in particular at least twice.

### CROSS-REFERENCE TO RELATED APPLICATION

The present application claims the benefit of priority of German Application No. 102010064125.1, filed Dec. 23, 2010. The entire text of the priority application is incorporated herein by reference in its entirety.

### FIELD OF THE DISCLOSURE

The disclosure relates to a container of a thermoplastic material, in particular a plastic bottle.

### BACKGROUND

Containers of thermoplastic material are often used, for example, in the food industry as containers for liquid products, for example beverages. The containers are usually molded from plastic preforms in a blow molding machine or in a stretch-blow molding machine. For this, the plastic preforms are first thermally conditioned and then molded to containers in so-called blow molds with the application of pressure.

The geometric shape of the produced container usually depends on requirements the product to be filled puts on the container. In addition, consumers put demands e.g. on the weight or stability of the container.

An important element of a container is its bottom. The bottom of plastic containers is often especially formed to have a higher stability. From DE 60 2004 010 814, for example, a container with a bottom is known which comprises several recesses leading from the center of the bottom to the outside. From US 2009/0308835, a container is moreover known whose bottom region comprises ribs in the form of grooves open to the outside.

A disadvantage of known containers is that they can only be manufactured with high blowing pressures in the blowing process. The shape of the bottom to be obtained often in particular aggravates the moldability of the containers in the blow molding machine or stretch-blow molding machine.

### SUMMARY OF THE DISCLOSURE

Therefore, it is one aspect of the present disclosure to provide a container of a thermoplastic material which is easier to mold when being manufactured. This object is achieved by a container according to patent claim 1.

The container of a thermoplastic material according to the disclosure, in particular a plastic bottle, includes:

a bottom comprising a first and a second surface area,

where the first and the second surface area, at a constant radius with respect to the longitudinal axis of the container, each have a constant distance to a plane surface arranged to be perpendicular to the longitudinal axis,

where the first surface area is offset with respect to the second surface area towards the interior of the container,

where the first and the second surface area are connected by a third surface area which is embodied in the form of a coherent loop band and comprises at least three loops, and

where the transition between the first surface area and the third surface area, and/or the transition between the second surface area and the third surface area are continuously differentiable at least once, in particular at least twice.

By the transitions to be achieved between the first and the third or the second and the third surface area of the container bottom being continuously differentiable at least once, the container, in particular the bottom, can be more easily manufactured in a blow-molding process. In particular, the required blowing pressure for manufacturing the container can be lower than the required blowing pressure for containers known from prior art, which usually is between 20 and 25 bar.

Container bottoms known from prior art often comprise edge-like shapings with roundings, that means transitions which are continuous but not continuously differentiable, at least once, in particular at least twice. To produce such edge-like shapings, a preform must be usually blown in a blow mold around corresponding edges of a blow mold bottom. For this, high blowing pressures are often required. In the manufacture of containers according to the disclosure, the required blowing pressure can be reduced due to the at least once, in particular at least twice continuously differentiable transitions.

The thermoplastic material can in particular comprise thermoplastic, for example PET (polyethylene terephthalate). The container can in particular be manufactured from a plastic preform in a blow molding process by application of compressed air in a blow mold. In addition, the preform can be stretched in the blow mold by means of a stretching rod (so-called stretch-blow molding).

The region of the container which comprises the base or support surface of the container can here be in particular defined as the bottom of the container. The bottom can in particular be arranged opposite to the mouth of the container.

The container can essentially be embodied in the form of a cylinder. In particular, the container can comprise concavely and/or convexly shaped partial areas, in particular in the region of the mouth and/or the lateral area of the container. In the region of the mouth of the container, an opening can be provided. The lateral area can be embodied to be conically tapering towards the opening.

The bottom of the container can also comprise a lower region of the lateral area of the container. In particular, the ratio of the diameter of the container to the height of the lower region can be 2 to 6. The height of the lower region can here be measured perpendicularly to a surface on which the container is placed in its intended orientation. The diameter of the container can correspond to the maximum, minimum or mean diameter of the container. The diameter of the container can be 30 mm to 170 mm, in particular 40 mm to 150 mm.

The lower region can in particular comprise a height of less or equal ⅓, ¼, ⅕ or ⅙ of the container's height.

The longitudinal axis of the container can in particular correspond to the axis of symmetry, in particular to the rotational axis of symmetry of the container. In other words, the container can be embodied to be rotationally symmetric with respect to the longitudinal axis.

The container can in particular be a bottle.

The first, the second and/or the third surface area can in particular face outwards. In other words, the first, the second and/or the third surface area can be arranged at the outer surface of the container.

The plane surface perpendicular to the longitudinal axis can in particular correspond to a surface on which the container is placed, in particular in its orientation as intended. The plane surface can in particular correspond to a horizontal surface.

The first and the second surface area can comprise, at a constant radius, a constant distance each to a plane surface arranged to be perpendicular to the longitudinal axis, in particular in a predetermined radial area, that means between a first predetermined radius and a second predetermined radius.

“Offset towards the interior of the container” can in particular mean that, if the plane surface is a support surface on which the container is arranged to be standing on the bottom of the container, the first surface area has, in a predetermined radial area, a greater distance from the support surface than the second surface area.

“Distance” can here in particular be understood as a normal distance.

In a further radial area in which the first and the second surface areas are arranged in particular in the region of a lateral area of the container, “offset towards the interior of the container” can also mean that the first surface area has a smaller distance to the longitudinal axis than the second surface area.

In other words, with at least a constant radius, the bottom can comprise, in the circumferential direction, several, in particular three or more, elevations and several, in particular three or more, indentations, in particular in an alternating manner. The elevations and indentations can have a constant distance to a plane surface which is arranged perpendicularly to the longitudinal axis of the container. The elevations and indentations can be interconnected each by a surface area with a variable distance to the plane surface, wherein the transition between an elevation and/or an indentation and the surface area with a variable distance to the plane surface is continuously differentiable at least once, in particular at least twice.

The expression “in the form of a coherent loop band” can here in particular mean that the third surface area completely surrounds the bottom. With a predetermined azimuthal angle, the third surface area can extend from an inner radius to an outer radius with respect to the longitudinal axis of the container. The inner radius and the outer radius can here vary depending on the azimuthal between a minimum inner radius and a maximum outer radius, in particular periodically. The connection of the points at the inner radius can be referred to as inner boundary line of the loop band. The connection of the points at the outer radius can be referred to as outer boundary line of the loop band.

The inner or outer boundary line, respectively, can also be referred to as inner or outer boundary contour.

“Azimuthal angle” can here be defined as the polar angle of cylinder coordinates, where the radial coordinate or the radius from the longitudinal axis or the axis of symmetry of the container and the height can be measured parallel to the longitudinal axis or the axis of symmetry of the container. In other words, in this case, the radius for points on the longitudinal axis or the axis of symmetry equals 0.

At least three loops can then mean that the minimum inner radius and the maximum outer radius are achieved at least three times.

The loops or loop segments of the loop band can in particular correspond to indentations. In other words, the central line of the loop band can be a coherent line which has at each point of the line the same normal distance to both boundary lines of the loop band, and which in particular does not intersect itself.

The distance of the central line from the longitudinal axis and/or the mathematical sign of the curvature of the central line can periodically vary over one circle around the container. The central line can in particular comprise sections with a convex (positive) curvature and sections with a concave (negative) curvature which periodically alternate. The value of the curvature in a section with a convex or concave curvature can be constant or variable.

“Continuously differentiable” in particular means that a derivative exists in the point of transition, and that the derivative is continuous. The transition between the first surface area and the third surface area, and/or the transition between the second surface area and the third surface area can be continuously differentiable at least once, in particular at least twice, in particular in the circumferential direction.

Continuously differentiable once can also be designated as “tangent continuous”, and continuously differentiable twice can also be designated as “curvature continuous”.

“In the circumferential direction” can in particular mean with a constant radius or distance from the longitudinal axis along the circumference of the container around the longitudinal axis.

In other words, the derivative can be formed tangentially to a circle with a predetermined radius which is concentric to the longitudinal axis. The derivative can in particular be formed in a direction perpendicular to the central line of the loop band at the constant radius. The derivative can be in particular formed along the surface of the bottom.

In particular, continuously differentiable at least once, in particular at least twice, can mean that the radius of curvature in the transition area between the first surface area and the third surface area, and/or in the transition area between the second surface area and the third surface area varies continuously, in particular does not comprise any discontinuities.

One can here in particular define a transition area as a partial area of the third surface area adjacent to the first or second surface area in which the distance to the plane surface approaches the constant value of the first or second surface area, respectively, but differs from the latter. The transition area can in particular comprise an extension which is ≦⅓, in particular ≦¼, in particular ≦⅕ of the width of a loop in the transverse direction.

The outer surface of the bottom of the container can comprise a free-form surface or correspond to such a free-form surface. “Free-form surface” can here in particular be defined as a surface which can be at least partially described by means of splines, that means piecewise polynomial functions. By this, at least once, in particular at least twice continuously differentiable transitions can be advantageously obtained.

In particular, a loop of the loop band can be described by a spline of the nth degree. By this, particularly smooth shapes in the container's bottom can be realized. A direction perpendicular to the running direction of the loop band can be here in particular referred to as transverse direction. The running direction of the loop band can extend along the central line of the loop band. In particular, the transition from the spline of the nth degree to the first and/or second surface area can be continuously differentiable at least once, in particular at least twice.

A spline of the nth degree is a function which is piecewise assembled from polynomials with a maximum degree n, n being here an integer greater or equal 2, and less or equal 7. The degree n can in particular be 2, 3, 5 or 7.

The in particular continuous line or curve at which the first or second surface area passes over into the third surface area can be designated as a transition between the first or the second surface area and the third surface area. The transition from the first to the third surface area can in particular correspond to the inner boundary line or boundary contour of the loop band. The transition from the second to the third surface area can in particular correspond to the outer boundary line or boundary contour of the loop band.

The outer and/or inner boundary line of a loop of the loop band can be described at least in sections by at least one spline of the nth degree and/or by at least one arc of a circle.

The transitions between the at least one spline of the nth degree and the at least one arc of a circle can be continuously differentiable at least once, in particular at least twice. By this, smooth transitions can be achieved whereby the container can be more easily molded than containers known from prior art in the manufacture in a blow molding machine.

The loop band can comprise at least 3 and at most 24 loops, in particular 3, 5, 6, 7, 8, or 12 loops.

The loop band can be rotationally symmetric to the longitudinal axis of the container.

The opening angle of a loop can be indirectly proportional to the number of loops of the loop band.

The geometry of a loop of the loop band can be minor-symmetrical to the bisector of the opening angle of the loop.

The bottom can at least partially comprise a curvature facing the interior of the container in the region of the first and the second surface area. By this, the stability of the bottom can be further increased.

The first surface area can comprise a first and a second partial area with a curvature facing the interior of the container, wherein the curvature of the first partial area differs from the curvature of the second partial area.

The container can be a container for still or pressurized products with an internal pressure of up to 2 bar, in particular up to 5 bar.

The container can have a filling volume of 100 ml to 5 l, in particular 250 ml to 2.5 l.

The disclosure moreover provides a method of designing a bottom of a container of a thermoplastic material, including:

designing a first and a second surface area,

where the first and the second surface area, at a constant radius with respect to the longitudinal axis of the container, each have a constant distance to a plane surface arranged to be perpendicular to the longitudinal axis,

where the first surface area is offset with respect to the second surface area towards the interior of the container,

designing a third surface area,

where the first and the second surface area are connected by the third surface area which is embodied in the form of a coherent loop band and comprises at least three loops, and

where the transition between the first surface area and the third surface area, and/or the transition between the second surface area and the third surface area are continuously differentiable at least once, in particular at least twice.

By this method, an easily manufactured, in particular easily moldable, bottom of a container can be designed.

In particular, the method of designing an above-described container can be used in particular for designing a bottom of an above-described container. The bottom, in particular the first, second and/or third surface area, can in particular comprise one or several ones of the above mentioned features.

Designing the bottom of the container can comprise designing a free-form surface.

Designing the first surface area can in particular comprise designing a first surface of revolution from a first contour. The first contour can comprise an arc of a circle with a first radius of curvature, a second arc of a circle with a second radius of curvature in particular differing from the first one, and a spline of the nth order. The transition between the first arc of a circle and the second arc of a circle and/or between the second arc of a circle and the spline can be continuously differentiable at least once, in particular at least twice. The first surface area can correspond to a partial area of the first surface of revolution.

Designing the second surface area can comprise designing a second surface of revolution from a second contour. The second contour can comprise an arc of a circle with a first radius of curvature, a second arc of a circle with a second radius of curvature in particular differing from the first one, and a spline of the nth order. The transition between the first arc of a circle and the second arc of a circle and/or between the second arc of a circle and the spline can be continuously differentiable at least once, in particular at least twice. The second surface area can correspond to a partial area of the second surface of revolution.

The first radius of curvature of the first contour can be equal to or different from the first radius of curvature of the second contour. The second radius of curvature of the first contour can be equal to or different from the second radius of curvature of the second contour. The spline of the first contour can be of the same order or of an order different from the spline of the second contour.

Designing the third surface area can moreover comprise designing a loop of the loop band. Designing the loop can comprise designing an outer and an inner boundary line of the loop, in particular wherein the inner and/or the outer boundary line comprise at least one arc of a circle and/or at least one spline of the nth order.

The disclosure moreover provides a container whose bottom has been designed according to an above described method.

The container, the bottom of the container and/or the method of designing the bottom can in particular comprise one or several ones of the above mentioned features.

The disclosure moreover provides a blow mold, comprising a bottom comprising a first and a second surface area,

where the first and the second surface area, at a constant radius with respect to the longitudinal axis of the blow mold, each have a constant distance to a plane surface arranged to be perpendicular to the longitudinal axis,

where the first surface area is offset with respect to the second surface area towards the interior of the blow mold,

where the first and the second surface area are connected by a third surface area which is embodied in the form of a coherent loop band and comprises at least three loops, and

where the transition between the first surface area and the third surface area, and/or the transition between the second surface area and the third surface area can be continuously differentiable at least once, in particular at least twice.

Blow mold bottoms known from prior art often have nearly sharp-edged transitions, that means transitions which are not continuously differentiable at least once, in particular at least twice. To blow a preform around such edges, high blowing pressures are often required. In a blow mold according to the disclosure, the required blowing pressure can be reduced due to the at least once, in particular at least twice constantly differentiable transitions.

The blow mold can in particular serve or be used for the manufacture of an above mentioned container in a blow molding machine, in particular from a plastic preform. The blow mold, in particular the blow mold bottom, can here in particular be designed such that an above mentioned container can be manufactured with it.

The bottom of the blow mold can in particular comprise one or several ones of the above mentioned features of the bottom of an above mentioned container. The surface of the bottom of the blow mold can in particular comprise a free-form surface or correspond to such a surface.

### BRIEF DESCRIPTION OF THE DRAWINGS

Further features and advantages of the disclosure will be illustrated below with reference to the exemplary figures. In the drawings:

FIGS. 1A-1C show an exemplary plan view, side view and an exemplary cross-section through an exemplary bottom of a container of a thermoplastic material;

FIGS. 2A and 2B show a plan view and a side view of an exemplary bottom of an exemplary container of a thermoplastic material;

FIG. 3 shows a plan view onto two exemplary bottoms of two exemplary containers of a thermoplastic material;

FIG. 4 shows a loop segment of a loop band of an exemplary bottom of a container of a thermoplastic material;

FIG. 5 shows a cross-section through an exemplary bottom of a container of a thermoplastic material;

FIG. 6 shows a cross-section through an exemplary bottom of a container of a thermoplastic material;

FIG. 7 shows a cross-section through an exemplary bottom of a container of a thermoplastic material;

FIG. 8 shows an overlay of two cross-sections through an exemplary bottom of a container of a thermoplastic material;

FIG. 9 shows a projection of half a loop segment of an exemplary bottom of a container of a thermoplastic material;

FIG. 10 shows a projection of half a loop segment of another exemplary bottom of a container of a thermoplastic material;

FIG. 11 shows a projection of half a loop segment of another exemplary bottom of a container of a thermoplastic material;

FIG. 12 shows a loop of an exemplary bottom of a container of a thermoplastic material;

FIG. 13 shows a perspective view of a loop of a loop band of an exemplary bottom of a container of a thermoplastic material; and

FIG. 14 shows a side view of a loop of a loop band of an exemplary bottom of a container of a thermoplastic material.

### DETAILED DESCRIPTION OF THE PREFERRED EMBODIMENT

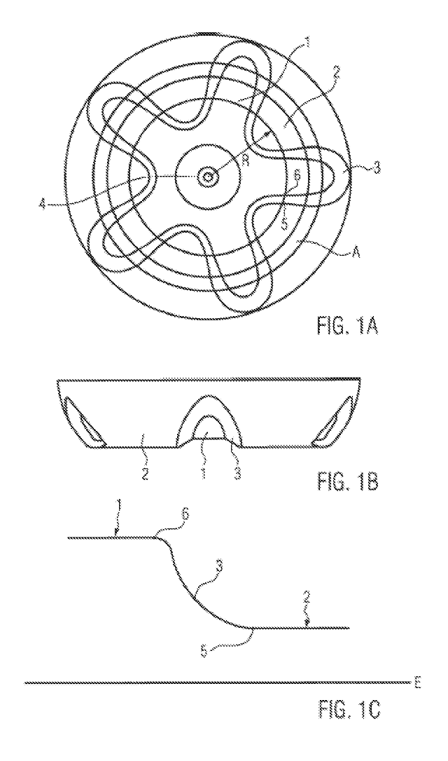

FIG. 1A shows a plan view of an exemplary bottom of a container of a thermoplastic material. The container can in particular be a plastic bottle, for example a PET bottle. The plan view in FIG. 1A is in particular a plan view onto the outer surface of the bottom side of the container, that means the side opposite to the mouth of the bottle on which the bottle is usually placed on a support surface, e.g. a table.

The bottom comprises a first surface area 1 and a second surface area 2. The first and the second surface areas 1, 2 have, at a constant radius R with respect to the longitudinal axis 4 of the container, each a constant distance to a plane surface arranged to be perpendicular to the longitudinal axis, for example the table, on which the container is arranged or placed.

The first surface area 1 is offset with respect to the second surface area 2 towards the interior of the container. In other words, the distance of the first surface area 1 to the support surface for the container is, at a predetermined radius R, greater than the distance of the second surface area 2 at the same radius R. This can apply in particular in a predetermined radial area, that means between a first predetermined radius and a second predetermined radius.

In other words, with a predetermined radius, several elevations and/or indentations can be present along the circumference of the container bottom, in particular in an alternating manner.

The first surface area 1 and the second surface area 2 are connected by a third surface area 3. The third surface area 3 is embodied in the form of a coherent loop band which contains five loops in this example.

With respect to the first surface area 1 and/or with respect to the second surface area 2, the third surface area 3 has a different distance to the plane surface which is arranged perpendicularly to the longitudinal axis and/or to the longitudinal axis 4 of the container.

In FIG. 1A, a predetermined radial area A is also shown on which the container usually rests on the support surface.

The first surface area 1 and the second surface area 2 comprise a curvature facing the container's interior within the support surface A.

The curve or the progression of contour of the loop band which separates the first surface area 1 or the second surface area 2 from the third surface area 3 can here be referred to as a transition between the first or the second surface area 1, 2 and the third surface area 3. The transition 5 between the second surface area 2 and the third surface area 3, and/or the transition 6 between the first surface area 1 and the third surface area 3 is continuously differentiable at least once, in particular at least twice.

By this, a particularly smooth transition between the first and the third or the second and the third surface area is achieved, which in turn permits an easy manufacture of the container, in particular with low blowing pressures.

FIG. 1B shows a side view of the exemplary bottom of FIG. 1A. Here, one can see that the first surface area 1 is offset with respect to the second surface area 2 towards the interior of the container.

FIG. 1C shows a cross-section through a portion of the exemplary bottom of FIG. 1A with a predetermined constant radius R. At the constant radius R, the first surface area 1 and the second surface area 2 each have a constant distance, in particular a normal distance, to a plane surface E which is arranged to be perpendicular to the longitudinal axis of the container. The distances of the two surface areas to the plane surface E, however, differ, wherein in particular the first surface area 1 is offset with respect to the second surface area 2 towards the interior of the container.

The transition 6 between the first surface area 1 and the third surface area 3 and the transition 5 between the second surface area 2 and the third surface area 3 is continuously differentiable at least once, in particular at least twice.

The section of the third surface area 3 between the transition 5 and the transition 6 can be described by a spline of the nth degree.

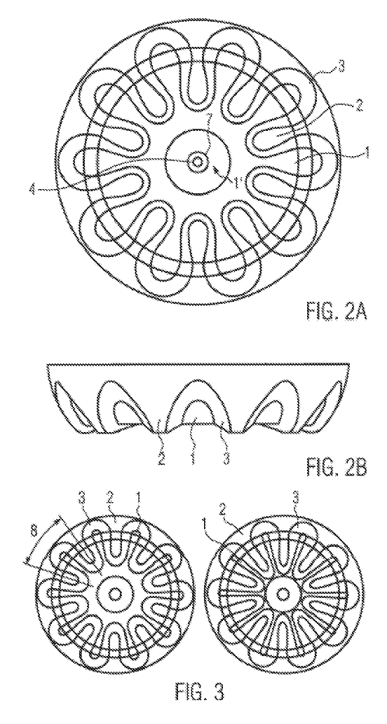

FIG. 2A shows a plan view of another exemplary container bottom of a thermoplastic material. The coherent loop band of the third surface area 3 in this example comprises ten loops.

FIG. 2A moreover shows a molding point 7 for centering the preform in the blow mold of a blow molding machine. The first surface area in this example at least partially comprises a curvature facing the interior of the container. In the region 1′, the curvature has a value different from that in partial areas of the first surface area outside the region 1′.

FIG. 2B shows a side view of the exemplary bottom of FIG. 2A.

FIG. 3 shows a plan view onto two further exemplary bottoms of containers of a thermoplastic material. Both bottoms have the same number of loops. The geometry of the loops of the two bottoms, however, differ from each other. By the loop geometry, the width of the third surface area 3 can be determined.

Moreover, the two exemplary bottoms in FIG. 3 differ by the radial area in which the third surface area 3 is arranged. In the example in the left of FIG. 3, the third surface area 3 extends in the radial direction from a first to a second predetermined radius, and in the right of FIG. 3, from a third predetermined radius to a fourth predetermined radius. In this example, both the third and the fourth predetermined radii are smaller than the first and the second predetermined radii, respectively.

By the shape of the coherent loop band of the third surface area 3, the areas and/or the ratio of the areas of the surface areas 1 and 2 can be varied.

In FIG. 3, the region of a loop 8 is moreover schematically indicated. The loop belt is in this example rotationally symmetric to the longitudinal axis of the container which in this example extends perpendicularly to the drawing plane.

The opening angle of the loop 8 can be selected to be proportional to the number of loops of the loop band. The loop band can comprise 3 to 24 loops. In particular, the opening angle of a loop can be determined according to the expression 360°/(number of loops).

The geometry of a loop of the loop band can be minor-symmetrical to the bisector of the opening angle of the loop.

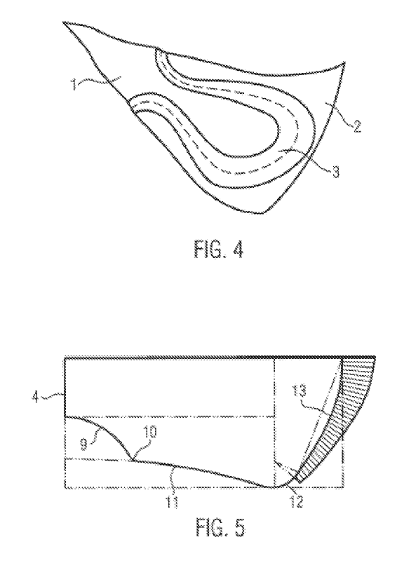

FIG. 4 shows a perspective view of a partial area of an exemplary bottom of a container of a thermoplastic material in which a loop segment of the loop band of the third surface area 3 is arranged. In the radial direction, the distance to a plane surface which is arranged to be perpendicular to the longitudinal axis can vary. At a constant radius with respect to the longitudinal axis, however, points of the first surface area 1 and of the second surface area 2 have a constant distance to a plane surface which is arranged to be perpendicular to the longitudinal axis.

In FIG. 4, the central line of the loop segment is moreover represented as a dashed line.

FIG. 5 illustrates the design of the second surface area of an exemplary bottom of a container of a thermoplastic material. In particular, the second surface area can be a partial area of a surface of revolution which is formed by rotation of the contour shown in FIG. 5 about the longitudinal axis 4.

This contour is defined by: a first dome radius 9, a radius of curvature 10, a second dome radius 11, the radius of the outer contour base 11, and a spline 13 of nth order which forms the transition to the lateral area of the container.

The transitions of the regions which are by the first dome radius 9, the radius of curvature 10, the second dome radius 11 and the radius of the outer contour base 12 can be continuously differentiable at least once. The transition from the radius of the outer contour base 12 to the spline 13 can also be continuously differentiable at least once, in particular at least twice.

The progression of curvature of the spline 13 can be described by a polynomial of the nth degree. The degree n of the spline 13 can be 2-7.

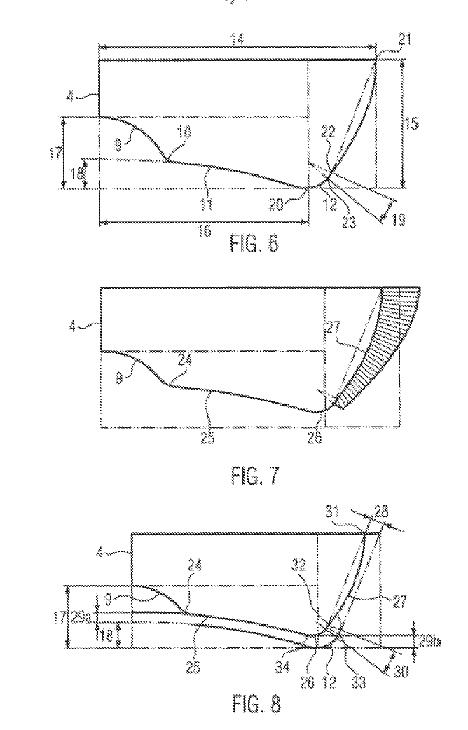

FIG. 6 illustrates further parameters for the design of an exemplary bottom of a container, in particular of the contour shown in FIG. 5.

The outer dimensions of the bottom are determined by the outer diameter 14 and the bottom height 15. The dimension of the standing circle diameter 16 is determined by a ratio to the outer diameter 14. The standing circle diameter designates the diameter with which the bottom of the bottle rests on a plane surface when the bottle is placed onto the plane surface. The standing circle diameter can in particular correspond to the mean value or median of the radii with which the bottom of the bottle rests on a plane surface when the bottle is placed onto the plane surface.

The ratio of the dimension of the standing circle diameter 16 to the outer diameter 14 can be between 0.615 and 0.935. The height 17 of the first dome radius 9 and/or the height 18 of the second dome radius 11 can be described by in particular different ratios to the outer diameter.

The starting point 23 of the spline 13 can be generated by a straight line between the points 21 and 22. The straight line between 21 and 22 is tangentially arranged at the base radius. The starting point 23 of the spline can be determined with the aid of an angle on the radius of the outer contour base 12 between the points 20 and 22. The tangent point of the straight line between 21 and 22 at the base radius can here be located perpendicularly to the center of the radius of the outer contour base 12.

FIG. 7 illustrates further aspects of a method of designing a bottom of a container of a thermoplastic material. FIG. 7 in particular shows a contour from which, with a rotation about the axis 4, a surface area is formed, wherein the first surface area in the examples shown above can be a subset of the surface area obtained by rotation of the contour.

The contour in FIG. 7 is described by a first dome radius 9, a radius of curvature 24, a third dome radius 25, a radius of the inner contour base 26 and a spline 27. The transitions of the individual regions can in turn be continuously differentiable at least once, in particular at least twice.

FIG. 8 shows further aspects of a method of designing a container bottom according to one of the previous examples. In FIG. 8, the contour shown in FIG. 7 and parts of the contour shown in FIGS. 5 and 6 are represented. In point 31, the spline 27 passes over into a straight line in an at least once, in particular at least twice continuously differentiable manner, the straight line being parallel to the outer diameter of the container. The straight line between the points 31 and 32 is parallel to the straight line between the points 21 and 22 in FIG. 6. The distance between these two straight lines can be defined via the dimension 28. The progression of curvature of the spline 27 for the contour shown in FIG. 7 can be described by a polynomial of the nth degree.

The distance between the inner contour and the outer contour can be defined via the dimension 29a. The distance between the point 34 and point 20 in FIG. 6 can be defined via the dimension 29b. At the points 34 and 20, the tangent to the inner contour or to the outer contour can be perpendicular to the longitudinal axis or parallel to a horizontal surface.

Dimensions 29a and 29b can be different. In particular, the dimension 29a can be less, equal or greater than dimension 29b.

The distance dimension 28 can also differ from or be equal to the distance dimension 29b. In particular, the distance dimension 29b can be less, equal or greater than the distance dimension 28.

One can determine by the dimensions 28 and 29b to what extent the first surface area is offset towards the interior of the container with respect to the second surface area.

The starting point 33 of the spline of the inner contour is generated by a straight line between the points 31 and 32. The straight line between 31 and 32 is tangential at the base radius 26. The starting point 33 can be determined with the aid of an angle 30 on the base radius 26 between the points 34 and 32. The dimension of the base radius 26 can be stated in a ratio to the base radius of the outer contour 12.

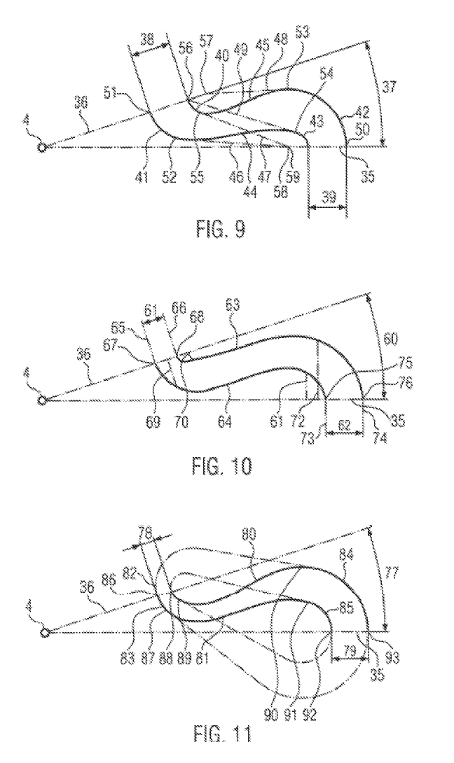

In FIGS. 9-11, three different loop geometries for the coherent loop band of the third surface area are illustrated. In particular, aspects of the design of the loop band are illustrated in these figures.

Since the loops are minor-symmetrical to the bisector, in FIGS. 9-11 only half a loop segment is represented each.

FIG. 9 shows a first alternative for a loop geometry. The longitudinal axis of the container 4 is represented together with the bisector 35 and a straight line 36 of the opening angle. In other words, the angle 37 between the straight line 35 and 36 is half the opening angle of the loop.

Point 51 is the next point to the longitudinal axis 4, that means it defines the inner boundary of the loop band (minimum inner radius of the loop band). The boundary in the radial direction for the point 51 is greater than or equal to the dimension or the radial extension of the first dome radius 9 in the previous images. The point 51 can maximally be located at the standing circle diameter 16 (FIG. 6).

The point 50 which represents the outer boundary of the loop band (maximum outer radius), that means the maximum radius a point of the third surface area assumes, can be selected between twice the dome radius 9 and the dimension of the outer diameter 14. In other words, the maximum radius a point of the third surface area assumes can be located within or outside the standing circle diameter 16.

The distance dimensions 38 and 39 define the width of the loop band along the bisector 35 or along the straight line 36 of the opening angle. The distance dimensions 38 and 39 can be equal or different. In particular, the ratio of the distance dimension 38 to the distance dimension 39 can be 0.215 to 3.

The inner boundary line of the loop, that means the transition between the first surface area and the third surface area, and/or the outer boundary line, that means the transition between the second surface area and the third surface area, can be described at least in sections by at least one spline of the nth degree and/or by at least one arc of a circle with a predetermined radius.

On the bisector 35, central points 58 and 59 with radii 42 and 43 are arranged.

The basic design of the inner boundary line of the loop is described by central points 56 and 58 and by the radii 41 and 43.

The point 52 of the inner boundary line of the loop is formed by the connection of the central point 58 with an auxiliary straight line 46 which is tangential to the radius 41. The tangent point is the transition point between the radius 41 and the spline 44. The point 54 of the inner boundary line of the loop is formed by the connection of the central point 56 with an auxiliary straight line 49 which is tangential to the radius 43. The tangent point is the transition point between the radius 43 and the spline 44.

The basic design of the outer boundary line of the loop is described by the central points 57 and 59 and by the radii 42 and 40.

The point 53 on the outer boundary line of the loop is formed by the connection of the central point 57 with an auxiliary straight line 48 which becomes tangential to the radius 42. The tangent point is the transition point between the radius 42 and the spline 45. The point 55 of the outer boundary line of the loop is formed by the connection of the central point 59 with an auxiliary straight line 47 which is tangential to the radius 40. The tangent point is the transition point between the radius 40 and the spline 45.

The inner boundary line of the loop, that means the transition between the first surface area and the third surface area, is described by an arc of a circle with a radius 41, a spline of the nth degree 44 and an arc of a circle with a radius 43. The transition from the arc of a circle with a radius 41 to the spline 44 in the point 52 can be continuously differentiable at least once, in particular at least twice. In point 54, the spline 44 passes over into the arc of a circle with a radius 43 continuously differentiably at least once, in particular at least twice.

The progression of curvature of the spline 44 between the points 52 and 54 can be described by a polynomial of the nth degree, wherein n can be in particular selected between 2 and 7.

The outer boundary line of the loop, that means the transition between the second surface area and the third surface area, is described by an arc of a circle with a radius 40, a spline 45, and an arc of a circle with a radius 42. The transition from the arc of a circle with a radius 40 to the spline 45 in the point 55 can be continuously differentiable at least once, in particular at least twice. In point 53, the spline 45 passes over into the arc of a circle with a radius 42 continuously differentiably at least once, in particular at least twice.

The progression of curvature of the spline 45 between the points 55 and 53 can also be described by a polynomial of the nth degree, wherein n is selected between 2 and 7.

FIG. 10 shows a second alternative for a loop geometry for the coherent loop band of the third surface area.

Point 67 is the next point to the longitudinal axis 4, that means it defines the inner boundary of the loop band. The boundary in the radial direction for the point 67 is greater than or equal to the dimension or the radial extension of the first dome radius 9 in the previous pictures. The point 67 can maximally be located at the standing circle diameter 16 (FIG. 6).

The point 76 which represents the outer boundary of the loop band, that means the maximum radius a point of the third surface area assumes, can be selected between twice the dome radius 9 and the dimension of the outer diameter 14. In other words, the maximum radius a point of the third surface area assumes can be located within or outside the standing circle diameter 16.

The distance dimensions 61 and 62 define the width of the loop band along the bisector 35 or along the straight line 36 of the opening angle. The distance dimensions 61 and 62 can be equal or different. In particular, the ratio of the distance dimension 61 to the distance dimension 62 can be 0.215 to 3.

In FIG. 10, auxiliary straight lines 65 and 66 are shown which are standing perpendicularly on the straight line 36 of the opening angle. The end points 67 and 68 of the auxiliary straight line 65 and 66 are located on the straight line 36 of the opening angle.

Moreover, FIG. 10 shows two further auxiliary straight lines 73 and 74 which are standing perpendicularly on the bisector 35 of the opening angle. The end points 75 and 76 of the auxiliary straight line 73 and 74 are located on the bisector 35.

The basic design of the inner boundary of the loop 65 is described by the auxiliary straight lines 65 and 73 and the support straight line perpendicular to 36 and perpendicular to 35.

The inner boundary line of the loop is described by the auxiliary straight line 65, a spline 64 and the auxiliary straight line 73. The transition from the auxiliary straight line 65 in the point 67 to the spline 64 can be continuously differentiable at least once, in particular at least twice. In point 75, the spline 64 passes over into the auxiliary straight line 73 continuously differentiably at least once, in particular at least twice. The spline 64 between the points 67 and 75 can be changed with the aid of the support straight lines 69 and 61. The dimensions for positioning the support straight lines 69 and 61 can be different or in relation to each other.

The progression of curvature of the spline 64 between the points 67 and 75 can be described by a polynomial of the nth degree, in particular with n 2 to 7.

The basic design of the outer boundary line of the loop is described by the auxiliary straight line 66 and the auxiliary straight line 74 as well as by the support straight line perpendicular to 36 and perpendicular to 35.

The outer boundary line of the loop is described by the auxiliary straight line 66, a spline 63 and the auxiliary straight line 74. The transitions between these elements in points 68 and 76, respectively, can be continuously differentiable at least once, in particular at least twice. The shape of the spline 63 can be changed with the aid of the support straight lines 70 and 72. The dimensions for positioning the support straight lines can be different or be in relation to each other.

The progression of curvature of the spline can be described by a polynomial of the nth degree, in particular with n 2 to 7.

FIG. 11 shows another alternative for a loop geometry for the coherent loop band of the third surface area.

Point 86 is the closest point to the longitudinal axis 4, that means it defines the inner boundary of the loop band. The boundary for the point 86 in the radial direction is greater or equal to the dimension or the radial extension of the first dome radius 9 in the previous pictures. The point 86 can be maximally located at the standing circle diameter 16 (FIG. 6).

Point 93, which represents the outer boundary of the loop band, that means the maximum radius a point of the third surface area assumes, can be between twice the dome radius 9 and the dimension of the outer diameter 14. In other words, the maximum radius a point of the third surface area assumes can be located within or without the standing circle diameter 16.

The distance dimensions 78 and 79 define the width of the loop band along the bisector 35 or along the straight line 36 of the opening angle, respectively. The distance dimensions 78 and 79 can be equal or different. In particular, the ratio of the distance dimension 78 to the distance dimension 79 can be 0.215 to 3.

The inner boundary of the loop contour is defined by the radii 82 and 85. The outer boundary of the loop contour is defined by the radii 83 and 84.

Tangential connections result between the radius 82 and the radius 85 and between the radius 83 and the radius 84. The tangent points 87 and 91 are transition points for a spline 81 of the inner contour of the loop, and the tangent points 89 and 90 are transition points for the spline 80 of the outer contour of the loop.

The inner contour of the loop is described by an arc of a circle with a radius 82, a spline 81 and an arc of a circle with a radius 85. The transitions between these elements can be continuously differentiable at least once, in particular at least twice. The radii 82 and 85 can be in relation to each other. The progression of curvature of the spline 81 can again be described by a polynomial of the nth degree, in particular with n 2 to 7.

The position of the central points of the radii can be equal or different, in particular be in relation to each other.

The radii 82 and 85 and the distances 78 and 79 can, however, also be in relation to each other.

The outer contour of the loop is described by an arc of a circle with a radius 83, a spline 80 and an arc of a circle with a radius 84. The transition between these elements can be continuously differentiable at least once, in particular at least twice.

The radii 83 and 84 can be in relation to each other. The progression of curvature of the spline 80 can again be described by a polynomial of the nth degree, in particular with n 2 to 7.

The position of the central points of the radii can be equal or different, in particular be in relation to each other.

The radii 83 and 84 and the distances 78 and 79 can, however, also be in relation to each other.

FIG. 12 shows a perspective view of a portion of a bottom of an exemplary container, wherein the portion comprises a loop of the loop band. In the region of the inner contour of the loop, the first surface area 1 passes over into the third surface area 3, and the third surface area 3 passes over into the second surface area 2 at the outer contour of the loop.

In the design of the bottom, section curves are generated on the first surface area 1 and on the second surface area 2 with the aid of auxiliary surfaces. The end points 102-115 of the section curves are connected with splines 95-101. The transitions of the splines 95-101 in the end points 102-115 are continuously differentiable at least once, in particular at least twice.

The splines 95-101 have a progression of curvature which is described by a polynomial of the nth degree, in particular wherein n is greater or equal 2 and less or equal 7.

With the aid of the inner and outer boundary contour of the loop and the splines 95-101, a free-form surface can be constructed which corresponds to the third surface area 3. The progression of curvature in the u- and v-direction of the free-form surface of the loop band can be described by polynomials of the nth degree.

The angular segment can then be multiplied about the axis of rotation with the number of loops that has been defined before. By this, the design of the loop band can be completed.

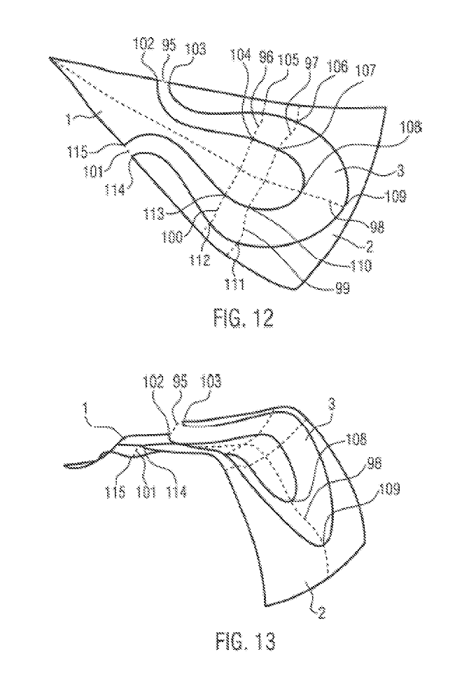

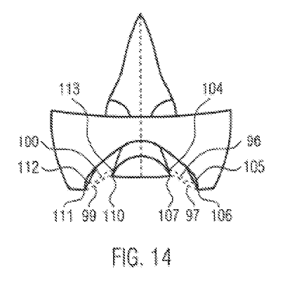

FIG. 13 shows another perspective view of a portion of the exemplary bottom of a container of a thermoplastic material which is represented in FIG. 12. FIG. 14 shows a corresponding side view.

It will be understood that features mentioned in the above described embodiments are not restricted to these special combinations and are also possible in any other combinations. The preceding examples can be applied, instead of to container bottoms, analogously also to bottoms of blow molds and their design.

1. A container of a thermoplastic material, particular a plastic bottle, comprising:
a bottom comprising a first and a second surface area,
wherein the first and the second surface area, at a constant radius with respect to the longitudinal axis of the container, each have a constant distance to a plane surface arranged to be perpendicular to the longitudinal axis,
wherein the first surface area is offset with respect to the second surface area (2) towards an interior of the bottle,
wherein the first and the second surface area are connected by a third surface area which is embodied in the form of a coherent loop band and comprises at least three loops, and
wherein one of a transition between the first surface area and the third surface area, a transition between the second surface area and the third surface area, and a combination thereof is continuously differentiable at least once.

2. The container according to claim 1, wherein a loop of the loop band is described in the transverse direction by a spline of n^{th} degree.

3. The container according to claim 1, wherein one of an outer boundary line, an inner boundary line, or a combination thereof of a loop of the loop band is described at least in sections by one of at least one spline of n^{th} degree, at least one arc of a circle, and a combination thereof.

4. The container according to claim 3, wherein transitions between the one of the at least one spline of n^{th} degree, the at least one arc of a circle, and a combination thereof are continuously differentiable at least once.

5. The container according to claim 1, wherein the loop band comprises between at least 3 and at most 24 loops.

6. The container according to claim 1, wherein the loop band is rotationally symmetric to the longitudinal axis of the container.

7. The container according to claim 1, wherein an opening angle of a loop is indirectly proportional to the number of loops of the loop band.

8. The container according to claim 1, wherein the geometry of a loop of the loop band is minor-symmetrical to the bisector of the opening angle of the loop.

9. The container according to claim 1, wherein the bottom at least partially comprises, in the region of the first and the second surface area, a curvature facing the interior of the container.

10. The container according to claim 9, wherein the first surface area comprises a first and a second partial area with a curvature facing to the interior of the container, wherein the curvature of the first partial area differs from the curvature of the second partial area.

11. The container according to claim 1, wherein the container is a container for one of still and slightly pressurized products up to an internal pressure of 5 bar.

12. The container according to claim 1, wherein the container comprises a filling volume in a range of 100 ml to 5 l.

13. A method of designing a bottom of a container of a thermoplastic material, comprising:
designing a first and a second surface area,
wherein the first and the second surface area, at a constant radius with respect to the longitudinal axis of the container, each have a constant distance to a plane surface arranged to be perpendicular to the longitudinal axis,
wherein the first surface area is offset with respect to the second surface area towards the interior of the container,
designing a third surface area,
wherein the first and the second surface area are connected by the third surface area which is embodied in the form of a coherent loop band and comprises at least three loops, and
wherein one of the transition between the first surface area and the third surface area, the transition between the second surface area and the third surface area, and a combination thereof is continuously differentiable at least once.

14. The container having a bottom designed according to the method of claim 13.

15. A blow mold comprising:
a bottom comprising a first and a second surface area,
wherein the first and the second surface area, at a constant radius with respect to the longitudinal axis of the blow mold, each have a constant distance to a plane surface arranged to be perpendicular to the longitudinal axis,
wherein the first surface area is offset with respect to the second surface area towards the interior of the blow mold,
wherein the first and the second surface area are connected by a third surface area which is embodied in the form of a coherent loop band and comprises at least three loops, and
wherein one of the transition between the first surface area and the third surface area, the transition between the second surface area and the third surface area, and a combination thereof are continuously differentiable at least once.

16. The container according to claim 1, wherein the container of a thermoplastic material is a plastic bottle.

17. The container according to claim 1, wherein the one of the transition between the first surface area and the third surface area, the transition between the second surface area and the third surface area, and the combination thereof, is continuously differentiable at least twice.

18. The container according to claim 4, wherein the transitions are continuously differentiable at least twice.

19. The container according to claim 5, wherein the loop based comprises one of 3, 5, 6, 7, 8, 10 and 12 loops.

20. The method of claim 13, wherein the one of the transition between the first surface area and the third surface area, the transition between the second surface area and the third surface area, and the combination thereof, is continuously differentiable at least twice.

21. The method according to claim 15, wherein the one of the transition between the first surface area and the third surface area, the transition between the second surface area and the third surface area, and the combination thereof, is continuously differentiable at least twice.
